(19) United States
(12) Patent Application Publication
(10) Pub. No.: US 2013/0044957 A1
(43) Pub. Date: Feb. 21, 2013

(54) METHODS AND APPARATUSES FOR ENCODING AND/OR DECODING MAPPED FEATURES IN AN ELECTRONIC MAP OF A STRUCTURE

(71) Applicants: Behrooz Khorashadi, San Diego, CA (US); Rajarshi Gupta, San Diego, CA (US)

(72) Inventors: Behrooz Khorashadi, San Diego, CA (US); Rajarshi Gupta, San Diego, CA (US)

(73) Assignee: QUALCOMM Incorporated, San Diego, CA (US)

(21) Appl. No.: 13/214,054

(22) Filed: Aug. 19, 2011

(51) Int. Cl. G06K 9/46

(52) U.S. Cl. 382/195

(57) ABSTRACT

Methods, apparatuses and articles of manufacture are provided that may be implemented or used in one or more electronic devices to generate an encoded map feature description corresponding to one or more mapped features of an electronic map of at least a portion of a structure. Methods, apparatuses and articles of manufacture are also provided that may be implemented or used in one or more electronic devices to decode at least a portion of an encoded map feature description.

### BACKGROUND

1. Field

The subject matter disclosed herein relates to electronic devices, and more particularly to methods and apparatuses for use in encoding and/or decoding one or more mapped features in one or more electronic maps of at least a portion of one or more structures.

2. Information

The Global Positioning System (GPS) represents one type of Global Navigation Satellite System (GNSS), which along with other types of satellite positioning systems (SPS) provide or otherwise support signal-based position location capabilities (e.g., navigation functions) in mobile devices, and particularly in outdoor environments. However, since some satellite signals may not be reliably received and/or acquired by a mobile device within an indoor environment or other like mixed indoor/outdoor environments, different techniques may be employed to enable position location services.

For example, mobile devices may attempt to obtain a position fix by measuring ranges to three or more terrestrial transmitters (e.g., wireless access points, beacons, cell towers, etc.) which are positioned at known locations. Such ranges may be measured, for example, by obtaining a MAC ID address from signals received from such transmitters and obtaining range measurements to the transmitters by measuring one or more characteristics of signals received from such transmitters such as, for example, signal strength, a round trip delay time, etc.

These and other like position location and navigation techniques tend to be of further benefit to a user if presented with certain mapped features. For example, mapped features may relate to or otherwise identify certain physical objects, characteristics, or points of interest within a building or complex, etc. However, such mapped features, particularly related to enhanced location based services and/or certain structures, may correspond to significantly large sized data files, which may need to be transmitted and/or stored.

### SUMMARY

In accordance with certain aspects, various methods and apparatuses are provided that may be implemented in one or more electronic devices to generate an encoded map feature description corresponding to one or more mapped features of an electronic map of at least a portion of a structure.

In certain example implementations, a method may be implemented at a computing device, which comprises: determining a plurality of regions within at least a portion of a structure based, at least in part, on one or more mapped features in an electronic map for the portion of the structure; determining a template description for a first region of the plurality of regions based, at least in part, on at least a portion of the electronic map; and determining a map feature distinction for at least a second region of the plurality of regions based, at least in part, on at least a portion of the template description.

In certain other example implementations, an apparatus may be provided which comprises: memory; and one or more processing units to: obtain an electronic map for at least a portion of a structure from the memory; determine a plurality of regions within the structure based, at least in part, on one or more mapped features in the electronic map; generate a template description for a first region of the plurality of regions based, at least in part, on at least a portion of the electronic map; and generate a map feature distinction for at least a second region of the plurality of regions based, at least in part, on at least a portion of the template description.

In still other example implementations, an apparatus may be provided for use in a computing device. Such an example apparatus may comprise: means for determining a plurality of regions within at least a portion of a structure based, at least in part, on one or more mapped features in an electronic map for the portion of the structure; means for establishing a template description for a first region of the plurality of regions based, at least in part, on at least a portion of the electronic map; and means for establishing a map feature distinction for at least a second region of the plurality of regions based, at least in part, on at least a portion of the template description.

In yet other example implementations, an article of manufacturing may be provided which comprises: a non-transitory computer readable medium having stored therein computer implementable instructions executable by one or more processing units in one or more computing devices to: determine a plurality of regions within at least a portion of a structure based, at least in part, on one or more mapped features in an electronic map for the portion of the structure; determine a template description for a first region of the plurality of regions based, at least in part, on at least a portion of the electronic map; and determine a map feature distinction for at least a second region of the plurality of regions based, at least in part, on at least a portion of the template description.

In accordance with certain other aspects, various methods and apparatuses are also provided that may be implemented in one or more electronic devices to decode at least a portion of an encoded map feature description.

In certain other example implementations, a method may be implemented at a mobile device, which comprises: obtaining an encoded map feature description corresponding to a plurality of regions of at least a portion of a structure, the encoded map feature description comprising template description for a first region of the plurality of regions, and a map feature distinction for at least a second region of the plurality of regions; and determining a decoded map feature description for at least the second region based, at least in part, on the template description and the map feature distinction.

In other example implementations, an apparatus may be provided which comprises: memory; and one or more processing units to: access an encoded map feature description corresponding to a plurality of regions of at least a portion of a structure, the encoded map feature description comprising template description for a first region of the plurality of regions, and a map feature distinction for at least a second region of the plurality of regions; and establish a decoded map feature description for at least the second region based, at least in part, on the template description and the map feature distinction.

In yet other example implementations, an apparatus may be provided for use in a mobile device. Such an example apparatus may comprise: means for obtaining an encoded map feature description corresponding to a plurality of regions of at least a portion of a structure, the encoded map feature description comprising template description for a first region of the plurality of regions, and a map feature distinction for at least a second region of the plurality of regions; and means for generating a decoded map feature description for at least the second region based, at least in part, on the template description and the map feature distinction.

In still other example implementations, an article of manufacture may be provided which comprises: a non-transitory computer readable medium having stored therein computer implementable instructions executable by one or more processing units in a mobile device to: obtain an encoded map feature description corresponding to a plurality of regions of at least a portion of a structure, the encoded map feature description comprising template description for a first region of the plurality of regions, and a map feature distinction for at least a second region of the plurality of regions; and determine a decoded map feature description for at least the second region based, at least in part, on the template description and the map feature distinction.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example environment that includes an encoder for encoding a map feature description (e.g., relating to one or more mapped features) and a decoder for decoding an encoded map feature description, in accordance with an implementation.

FIG. 2 is a schematic block diagram illustrating certain features of an example computing device to generate an encoded map feature description, in accordance with an implementation.

FIG. 3 is a schematic block diagram illustrating certain features of an example mobile device to decode an encoded map feature description, in accordance with an implementation.

FIG. 4 is an illustrative block diagram of an example encoded map feature description, in accordance with an implementation.

FIG. 5 is a functional flow diagram illustrating certain features of an example method for use in one or more computing devices to generate an encoded map feature description, in accordance with an implementation.

FIG. 6 is a functional flow diagram illustrating certain features of an example method for use in a mobile device to decode an encoded map feature description, in accordance with an implementation.

FIG. 7, FIG. 8 and FIG. 9 are illustrative diagrams showing certain example common design characteristics and differences between two example regions, in accordance with an implementation.

FIG. 10 is an illustrative diagram relating to an example mapped feature encoding technique for two example regions, in accordance with an implementation.

FIG. 11 is an illustrative diagram showing that certain example common design characteristics may exist in a plurality of regions having different orientations or scales, in accordance with an implementation.

### DETAILED DESCRIPTION

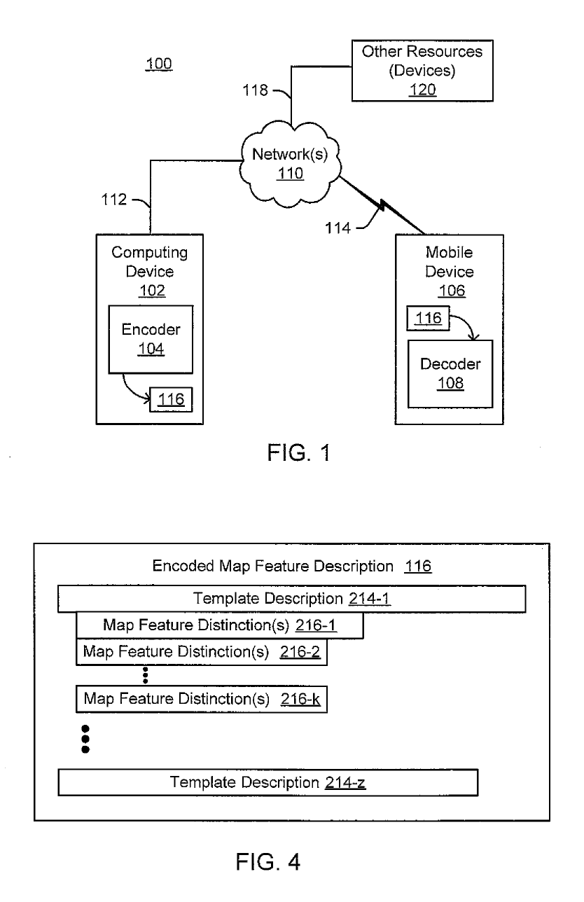

FIG. 1 illustrates an example environment 100 comprising a computing device 102 having an encoder 104. Encoder 104 may, for example, generate an encoded map feature description 116 based, at least in part, on one or more mapped features of an electronic map (not shown) for a structure (not shown). Computing device 102 may be connected to one or more wired and/or wireless network(s) 110 via a communication link 112. A mobile device 106 may, for example, be coupled to network(s) 110 via a wireless communication link 114. As such, an encoded map feature description 116 may be transmitted or otherwise provided by computing device 102 to mobile device 106. Mobile device 106 may, for example, comprise a decoder 108 which may decode all or part of an encoded map feature description 116. Network(s) 110 may, for example, be further connected to one or more other resources (devices) 120, e.g., via communication link 118. In certain example implementations, computing device 102 may obtain an electronic map with mapped feature(s) for a structure from other resources (devices) 120.

In certain example implementations, encoder 104 may identify a plurality of regions within a structure based, at least in part, on one or more electronic maps for the structure. The term “structure” may, for example, apply to (all or part of) one or more natural and/or man-made physical arrangements of object(s), the knowledge of which may be of use to a user of mobile device 106. For example, a structure may comprise one or more buildings or a portion thereof. In certain particular examples, a structure may comprise a multiple floor office building having common design characteristics within regions therein. For example, two or more regions (e.g., floors or levels, or other sections) of a building may have common design characteristics. For example, a common design characteristic may relate to a similar internal architectural or office space floor plan, a similar set of navigational routes, and/or similar wireless network node arrangements, etc. The term “region” may, for example, apply to a portion of a structure for which one or more mapped features in an electronic map may be of use to a user of mobile device 106. Thus, for example, a region may comprise one or more rooms, floors, etc., or portions thereof within at least a portion of a structure. In certain example implementations, all or part of a region may be defined, at least in part, on features identified in one more electronic maps. A feature may, for example, identify a design characteristic (e.g. office layout, etc.), an object (e.g., a wail, a door, an elevator, a staircase, a statue, etc.), an entity and/or service (e.g., a business, a taxi stand, a restroom, a doctor's office, a lost and found department, a security station, etc.), and/or any other navigational, location based service characteristic which may be identified via representative data in one or more files of an electronic map. Of course these are simply a few examples and, as with all of the examples presented herein, claimed subject matter is not necessarily intended to be so limited.

With this in mind, in certain example implementations, encoder 104 may further identify a template description for a first region of a plurality of regions based, at least in part, on at least a portion of one or more electronic maps. As described in greater detail below, encoder 104 may, for example, in selecting one of a plurality of regions take into account various common design characteristics that certain regions may share. For example, encoder 104 may consider whether certain regions have similar floor plans, similar navigational routes, and/or similar wireless node arrangements. Here, for example, if it is determined that a subset of regions have certain common design characteristics, then one of these regions may be identified as a template from which the other regions in the subset may be compared to.

In certain instances, encoder 104 may select a particular region as a template based, at least in part, on other selection criteria that may be available. For example, encoder 104 may consider a number of common design characteristics for a region, a location of a region, or a usage parameter for the region. Thus, in certain instances it may be useful to select a region with a relatively high number of common design characteristics. In other instances, however, it may be useful to limit a number of common design characteristics. The location of a region may be taken into consideration since it may be useful in certain instances to select a region as a template due to a number of entryways and/or exits it presents (e.g., ground floor), and/or its location to some particular point of interest (e.g., elevators, food court, reservation desk, parking garage, etc.). Similarly, a metric or other like usage parameter for actual or estimated user traffic within the various regions may also prove useful in selecting a region as a template. Indeed, in certain example implementations, encoder 104 may determine a usage parameter based, at least in part, on feedback generated by and/or collected from a plurality of mobile devices. For example, feedback may be gathered and/or otherwise processed over time using so-called “crowd sourcing” or other like techniques which allow traffic patterns or other like useful information regarding the users of mobile devices within a structure and/or those using various location based services therein to be identified in some manner.

It may also be useful to consider the level of detail available in an electronic map with regard to various regions, as it may be beneficial to select a region as a template based on how large (representative data wise) one may want a resulting template description file to be.

Having identified applicable template description, e.g., using various techniques such as those described in the examples above, encoder 104 may, for example, identify a set of map feature distinctions (e.g., comprising zero or more distinctions) for at least a second region of the plurality of regions based, at least in part, on at least a portion of a template description. For example, rather than replicating map features common to both the first and second regions, encoder 104 may provide a template description for the first region and map feature distinctions for the second region, and other possible regions. Map feature distinctions may, for example, be indicative of differences between applicable electronic map feature description for the region(s) which share come common design characteristics with the region selected as a template.

As mentioned, computing device 102 may transmit an encoded map feature description 116 to mobile device 106. In certain example implementations, an encoded map feature description 116 may comprise one or more template descriptions and possibly one or more map feature distinctions or one or more sets of map feature distinctions. One potential benefit to an encoded map feature description 116 is that in most instances an amount (size) of encoded data of the encoded map feature description may be less than that of one or more corresponding, applicable electronic map(s). As such, data communication and/or storage overhead in transmitting and/or storing such encoded data within environment 100 may be reduced.

While examples presented herein tend to describe regions as being floors within a building, it should be kept in mind that in certain other example implementations, a structure may comprise one or more buildings and the first and second regions may be located on: different levels of one of the buildings; on one level one of the buildings; or in different buildings.

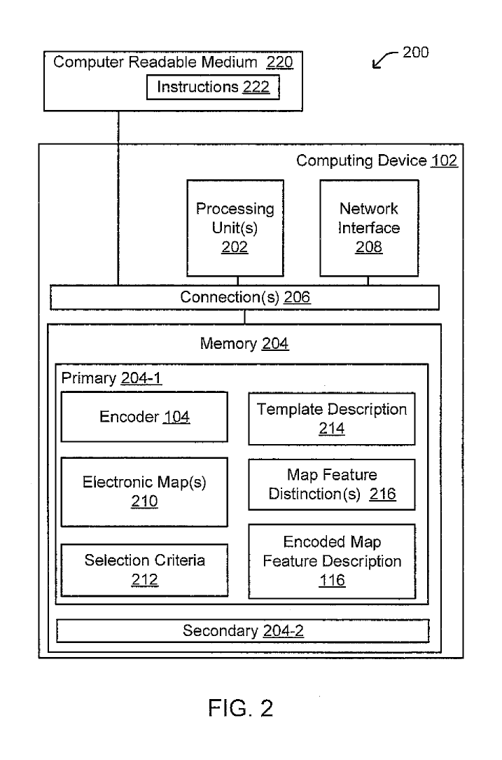

Reference is made next to FIG. 2, which is a schematic block diagram illustrating certain features of computing device 102, for example as in FIG. 1, in accordance with an implementation.

As illustrated computing device 102 may comprise one or more processing units 202 to perform data processing (e.g., in accordance with the techniques provided herein) coupled to memory 204 via one or more connections 206. Processing unit(s) 202 may, for example, be implemented in hardware or a combination of hardware and software. Processing unit(s) 202 may, for example, be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, etc. While illustrated in this example as being separate from the processing units, it should be understood that all or part of a primary memory may be provided within or otherwise co-located/coupled with processing unit(s) 202, or other like circuitry within computing device 102. Secondary memory 204-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, a (non-transitory) computer readable medium 220. Memory 204 and/or computer readable medium 220 may comprise computer-implementable instructions 222 for certain example techniques as provided herein.

As illustrated in FIG. 2, at various times memory 204 may store certain signals representing data and/or computer-implementable instructions for certain example techniques as provided herein. For example, memory 204 may store data and/or computer-implementable instructions for encoder 104. By way of example, memory 204 may at various times store representative data for an electronic map 210, selection criteria 212, a template description 214, one or more sets of map feature distinction(s) 216, and/or an encoded map feature description 116.

As shown, computing device 102 may, for example, comprise a network interface 208. Network interface 208 may, for example, provide a capability to receive and/or transmit wired and/or wireless signals, e.g., to communicate via network(s) 110 (FIG. 1).

In certain example implementations, computing device 102 may take the form of a server or other like device. In certain example implementations, computing device 102 may take the form of a wireless network element, or other location based service element. In certain example implementations, computing device 102 may take the form of a portion of a cloud computing configuration. In certain example implementations, computing device 102 may take the form of a wireless access point or other like local area computing resource.

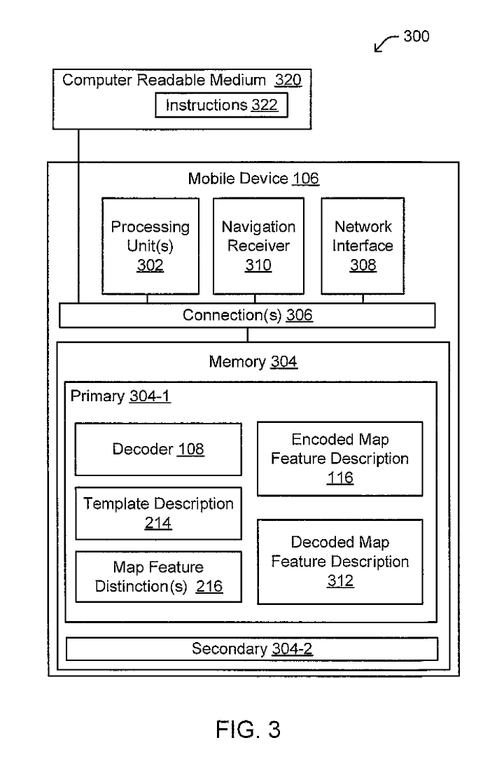

Reference is made next to FIG. 3, which is a schematic block diagram illustrating certain features of mobile device 106, for example as in FIG. 1, in accordance with an implementation.

As illustrated mobile device 106 may comprise one or more processing units 302 to perform data processing (e.g., in accordance with the techniques provided herein) coupled to memory 304 via one or more connections 306. Processing unit(s) 302 may, for example, be implemented in hardware or a combination of hardware and software. Processing unit(s) 302 may, for example, be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 304 may be representative of any data storage mechanism. Memory 304 may include, for example, a primary memory 304-1 and/or a secondary memory 304-2. Primary memory 304-1 may comprise, for example, a random access memory, read only memory, etc. While illustrated in this example as being separate from the processing units, it should be understood that all or part of a primary memory may be provided within or otherwise co-located/coupled with processing unit(s) 302, or other like circuitry within mobile device 106. Secondary memory 304-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, a (non-transitory) computer readable medium 320. Memory 304 and/or computer readable medium 320 may comprise computer-implementable instructions 322 for certain example techniques as provided herein.

As illustrated in FIG. 3, as various times memory 304 may store certain signals representing data and/or computer-implementable instructions for certain example techniques as provided herein. For example, memory 304 may store data and/or computer-implementable instructions for decoder 108. By way of example, memory 304 may at various times store representative data for an encoded map feature description 116, a template description 214, one or more sets of map feature distinctions 216, and/or a decoded map feature description 312.

As shown, mobile device 106 may, for example, comprise a network interface 308. Network interface 308 may, for example, provide a capability to receive and/or transmit wired and/or wireless signals, e.g., to communicate via network(s) 110 (FIG. 1).

As shown, mobile device 106 may, for example, comprise a navigation receiver 310, which may provide position location and/or other navigation services based on wireless signals transmitted by various transmitting devices. For example, navigation receiver 310 may comprise an SPS receiver capable of receiving and processing one or more Global Navigation Satellite Systems (GNSSs), or other like satellite and/or terrestrial locating services, such as, e.g., one or more location based services (LBSs) which may be provided, at least in part, by a cellular network, a WiFi network, etc.

Mobile device 106 is representative of any electronic device that may be moved about within environment 100. For example, mobile device 106 may comprise a hand-held computing and/or communication device, such as, a mobile telephone, smart phone, lap top computer, tablet computer, navigation device, and/or the like. In certain example implementations, mobile device 106 may be part of a circuit board, an electronic chip, etc.

It should be understood that mobile device 106 may also or alternatively comprise one or more other circuits, mechanisms, etc., (not shown) that may be of use in performing one or more other functions or capabilities, and/or supportive of certain example techniques as provided herein. For example, mobile device 106 may comprise one or more input/output devices (e.g., a display, a touch pad, a key pad, a button, a port, a digital camera, a speaker, a microphone, etc.), a power supply (e.g., a battery), and/or the like.

Computing device 102 and/or mobile device 106 may, for example, be enabled (e.g., via one or more network interfaces) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

Reference is made next to FIG. 4, which is an illustrative diagram depicting an example encoded map feature description 116. Here, for example, a data file may represent an encoded map feature description 116 and comprise data representing a template description 214-1 through 214-z for a plurality of regions. In this example, a template description 214-1 may comprise data representing a set of map feature distinctions 216-1 through 216-k. Template description 214-z, in this example, may not comprise data representing any particular map feature distinctions (e.g., there may have been no similar regions, etc.). It should be understood that in certain instances, all or part of the data representing an encoded map feature description 116 may be compressed, encrypted and/or otherwise manipulated for various reasons without departing from the scope subject matter claimed herein.

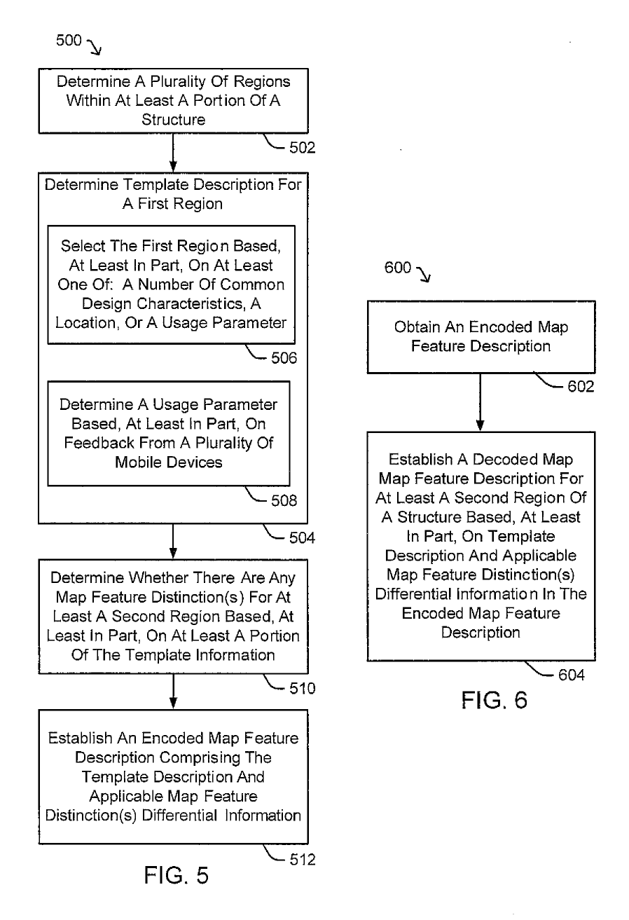

Attention is drawn next to FIG. 5, which is a flow diagram illustrating an example method 500 for use in computing device 102, in accordance with an implementation.

At block 502, for example, a plurality of regions within a structure may be identified, e.g., within an electronic map or other like data file(s).

At block 504, for example, a template description for a first region of a structure may be identified. In certain example implementations, at block 506, a first region may be selected based, at least in part, on at least one of: a number of common design characteristics, a location, or a usage parameter. In certain example implementations, at block 508, a usage parameter may be determined based, at least in part, on feedback generated by or otherwise gathered from a plurality of mobile devices, e.g., with regard to a structure or a region therein.

At block 510, for example, one or more sets of map feature distinctions may be identified for at least a second region of the structure based, at least in part, on at least a portion of a template description and/or a comparison thereto.

At block 512, for example, an encoded map feature description comprising at least one template description and possibly one or more sets of map feature distinctions may be transmitted or otherwise provided to one or more mobile devices. For example, a processing unit may generate an encoded map feature description comprising at least one template description and one or more map feature distinctions, and initiate transmission of at least a portion of the encoded map feature description to a mobile device, e.g., via a network interface.

Attention is drawn next to FIG. 6, which is a flow diagram illustrating an example method 600 for use in mobile device 106, in accordance with an implementation.

At block 602, for example, an encoded map feature description for a structure may be obtained. Here, for example, an encoded map feature description may be received from one or more computing devices over one or more networks. An encoded map feature description may, for example, comprise at least one template description for one or more regions of a structure along with one or more sets of map feature distinctions for one or more other regions of the structure.

At block 604, for example, a decoded map feature description for at least a second region of the structure may be determined based, at least in part, on a template description for a first region and a set of map feature distinctions for at least the second region of the structure.

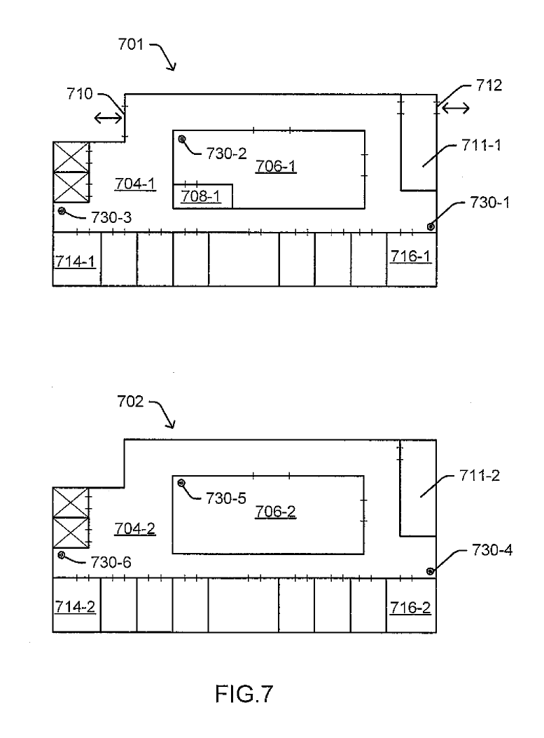

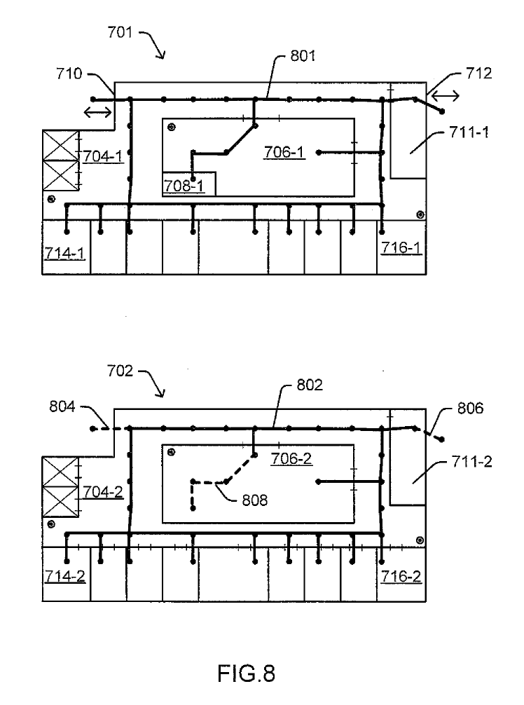

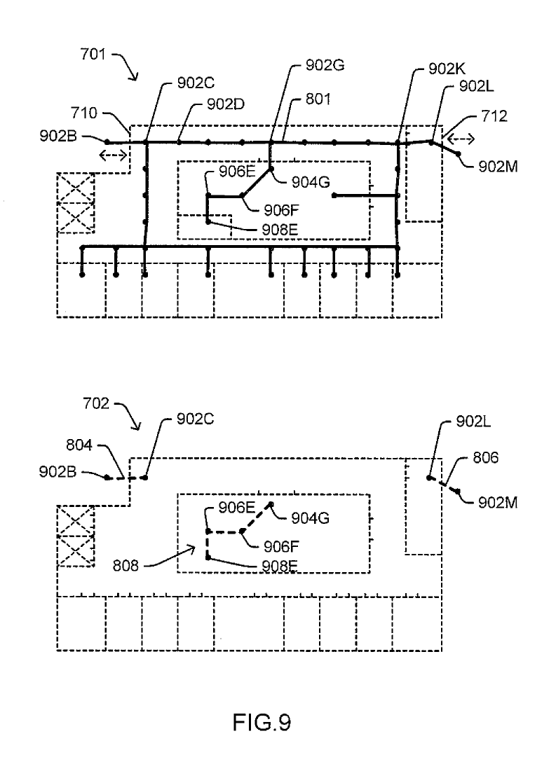

Attention is drawn next to FIG. 7, which is an illustrative diagram showing certain example illustrated mapped features that may be represented via data (representative data) in an electronic map with regard to at least a portion of an example structure. Here, for example, a region 701 and a region 702 of a structure are shown in a floor plan drawing as having certain common design characteristics. For example, both regions have essentially the same office or room lay out designs, with a few exceptions. For example, regions 701/702 have a similarly shaped passageways 704-1/704-2, and similarly located and sized corner offices 714-1/714-2 and 716-1/716-2, respectively. For example, both regions 701/702 have similarly positioned wireless node arrangements as represented by various example access points 730-1 through 730-6. There are some differences however, for example, region 701 has a small room 708-1 within conference room 706-1, which region 702 does not have. Additionally, for example, unlike region 702, region 701 has an entryway 710 and also an emergency exit 712 for staircase 711-1, which is not present for staircase 711-2 in region 702.

Attention is drawn next to FIG. 8, which is similar to FIG. 7, but which adds an illustrative set of navigational grid points and route connections which may be provided in electronic map to support location based services, etc., with regard to a structure. For example, a navigational route 801 is shown overlaid on region 701 and a similar navigational route 802 is shown overlaid on region 702. Here, some differences are illustrated in navigational route 802 by dashed line sections. For example, dashed line section 804 is only applicable to region 701 since this portion of the navigational route relates to entryway 710. For example, dashed line section 806 is only applicable to region 701 since this portion of the navigational route relates to emergency exit 712. For example, dashed line section 808, traversing conference room 706 to access small room 708-1 is only applicable to region 701 since no such small room is present in region 702.

Considering the example regions 701 and 702 in FIGS. 7 and 8, it should be recognized that there are several common design characteristics and hence one of these regions may, for example, be selected as a template and a template description may be identified accordingly. The other region may, for example, be compared to the template description and an applicable set of map feature distinctions may be identified. In this present example, various selection criteria may be considered in selecting one of these regions as a template. For example, it appears that region 701 may be on a ground floor since it has entryway 710 and emergency exit 712. Thus, this location and/or possibly a corresponding usage parameter may tend to make region 701 a better choice as a template in certain instances. Thus, a set of map feature distinctions for region 702 may, for example, focus on identifying applicable differences in the mapped features between regions 701 and 702.

Accordingly and by way of example, FIG. 9, which is similar to FIG. 8, illustrates that region 701 and in a particular example navigational route 801 may be selected as a template and an applicable template description may be established. Further, a set of map feature distinctions for region 702 may be established to indicate that dashed line sections 804, 806 and 808 may be removed from the template description, the result of which would be to describe navigational route 802. By way of example, a template description for region 701 in FIG. 9 may indicate, at least in part, that routes exist between grid points 902B-902C-902D; 902G-904G-906F-906E-908E; and 902K-902L-902M. By way of example, a set of map feature distinctions for region 702 in FIG. 9 may indicate, at least in part, that no routes exist between grid points 902B-902C (e.g., illustrated by dashed line section 804); 904G-906F-906E-908E (e.g., illustrated by dashed line section 808); and 902L-902M (e.g., illustrated by dashed line section 806).

Assume for a moment that, in the above examples, there are five other regions substantially the same as region 702. In this situation, rather than select region 701, it may be more beneficial to select region 702 or one of the other five substantially same regions as a template to reduce the amount of data in one or more corresponding sets of map feature distinctions.

Although not shown, it should be recognized that an electronic map feature description may comprise representative data about more than just a region's physical arrangement. For example, representative data may be provided to identify a wireless signal/service “heat map” for a wireless node arrangement. For example, a heat map may identify certain signaling characteristics which may be of use in position location or other like navigation processes. For example, a heat map may identify expected or probable signal strengths (e.g., RSSI), and/or other signal propagation and/or timing measurements or estimates (e.g., RTT), e.g., at various points or position locations within a structure or portion (e.g., region) thereof. Given the apparent structural and layout similarities in the example regions 701 and 702, and matched location and pattern of wireless node arrangements (e.g., access points, etc.), it may be that the heat map or other like signaling characteristics for these two regions may represent a common design characteristic. Thus, template and map feature distinctions may comprise heat map or other like representative data.

While FIG. 7 illustrates a wireless node arrangement with various example access points 730 located within regions 701 and 702, in other example implementations one or more of the access points or other like transmitting devices (e.g., cell towers, repeaters, location beacons, SPS transmitters, etc.) may be located external to a region while serving mobile devices within the region. Hence, in certain instances, a template and one or more sets of map feature distinctions may comprise or relate to a heat map, e.g., based on expected received signal strengths such as received signal strength indicator (RSSI), etc., or other like representative data for one or more such applicable nodes/signals. In certain instances, a template and one or more sets of map feature distinctions may comprise or relate to signal propagation timing, e.g., based on an expected signal trip delays, expected signal round trip delays, expected time difference of arrivals, etc., or other like representative data relating to signaling to or from one or more such applicable nodes.

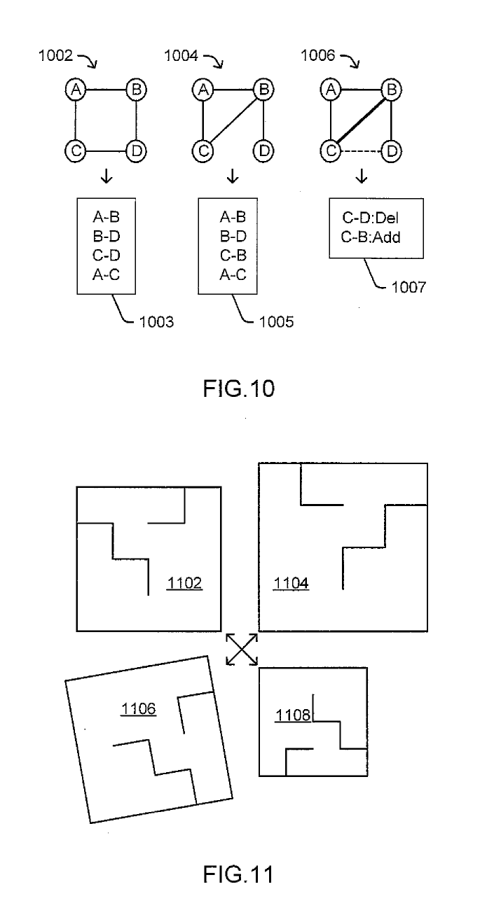

Attention is drawn next to FIG. 10, which illustrates by way of a simple example, one possible technique that may be used to encode a map feature description. Here, for example, a route 1002 and related map feature description 1003 are shown for a portion of a navigational route within a first region. Map feature description 1003 indicates applicable connections (routes) between points A, B, C, and D within the first region, e.g., as illustrated in route 1002. For example, a user may travel directly between point A and point B, directly between point B and point D, etc., as illustrated by applicable lines drawn between such points in route 1002. However, in this example first region a user may not travel directly between point B and point C.

A route 1004 and related map feature description 1005 are shown for a portion of a navigational route within a second region. Map feature description 905 is similar to map feature description 1003 in that it also indicates certain applicable connections (routes) between points A, B, C, and D. For example, in this example second region a user may travel directly between point A and point B, directly between point B and point D, etc., as illustrated by applicable lines drawn between such points in route 1004. There are, however, two differences between map feature description 1003 and map feature description 1005. One difference is that in this example second region a user may travel directly between point B and point C, which was not possible in the example first region. Another difference is that in this example second region a user may not travel directly between point C and point D. These differences are illustrated in route 1006.

With these example similarities and differences in mind, let us assume the example first region is identified as a template and that map feature description 1003 represents the template description. Thus, for example, differences between map feature description 1003 (here, the selected template description) and map feature description 1005 may be indicated by an example set of map feature distinctions 1007. In this simple example, a set of map feature distinctions 1007 indicates how a template description (map feature description 1003) may be altered to reproduce map feature description 1005. Thus, for example, a set of map feature distinctions 1007 indicates by “B-D:Del”, that the direction connection (route) between points B and D is to be deleted (indicated by “Del”). Further, for example, map feature distinctions 1007 indicates by “C-B:Add”, that a direction connection (route) between points C and B is to be added (indicated by “Add”). Furthermore, while map feature description 1003 may include the positions (or relative positions) of the nodes A, B, C, D, such information may not be needed in map feature distinctions 1007.

Thus, as illustrated by the above example, rather than having to transmit and store a map feature description comprising both 1003 and 1005, it may be possible to transmit and store corresponding encoded map data comprising a template description (map feature description 1003) and a set of map feature distinctions 1007.

Attention is drawn next to FIG. 11, which is intended to illustrate that in certain instances, it may be possible to encode a map feature description for regions which may be similar and share common design characteristics but which may also have different orientations or sizes (different scale). Thus, for example, regions 1102, 1104, 1106 and 1108 may be determined to be similar and share common design characteristics even though they have different orientations (e.g., mirror copies, flipped, rotated, etc.) and/or different scales (e.g., relatively larger or smaller). Hence, for example, a set of map feature distinctions may comprise orientation and/or scaling parameters which may indicate how all or part of a template description for a first region may be altered to reproduce all or part of a map feature description for a second region.

Reference throughout this specification to “one example”, “an example”, “certain examples”, or “example implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information (e.g., as representative data). It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, at a computing device:
determining a plurality of regions within at least a portion of a structure based, at least in part, on one or more mapped features in an electronic map for said portion of said structure;
determining a template description for a first region of said plurality of regions based, at least in part, on at least a portion of said electronic map; and
determining a map feature distinction for at least a second region of said plurality of regions based, at least in part, on at least a portion of said template description.

2. The method as recited in claim 1, and further comprising at said computing device:
transmitting an encoded map feature description to a mobile device, said encoded map feature description comprising said template description and said map feature distinction.

3. The method as recited in claim 2, wherein said template description is for at least one of: a floor plan for said first region, a navigational route for said first region, or a wireless node arrangement for said first region.

4. The method as recited in claim 2, wherein said template description is for a wireless node arrangement for said first region and is indicative, at least in part, of at least one of: a signal strength for a signal transmitted by a wireless transmitting device; or a signal propagation time for said signal.

5. The method as recited in claim 1, wherein said first and second regions share a common design characteristic.

6. The method as recited in claim 5, wherein said common design characteristic comprises at least one of: a similar floor plan, a similar navigational route, or a similar wireless node arrangement.

7. The method as recited in claim 1, and further comprising at said computing device:
selecting said first region of said plurality of regions based, at least in part, on at least one of: a number of common design characteristics, a location, or a usage parameter.

8. The method as recited in claim 7, and further comprising at said computing device:
determining said usage parameter based, at least in part, on feedback from a plurality of mobile devices.

9. The method as recited in claim 1, wherein said portion of said structure comprises one or more buildings and said first and second regions are located:
on different levels of a first one of said one or more buildings;
on one level of said first one of said one or more buildings; or
in different ones of said one or more buildings.

10. An apparatus comprising:
memory; and
a processing unit to:
obtain an electronic map for at least a portion of a structure from said memory;
determine a plurality of regions within said structure based, at least in part, on one or more mapped features in said electronic map;
generate a template description for a first region of said plurality of regions based, at least in part, on at least a portion of said electronic map; and
generate a map feature distinction for at least a second region of said plurality of regions based, at least in part, on at least a portion of said template description.

11. The apparatus as recited in claim 10, and further comprising:
a network interface; and
said processing unit to further:
generate an encoded map feature description comprising said template description and said map feature distinction; and
initiate transmission of at least a portion of said encoded map feature description to a mobile device via said network interface.

12. The apparatus as recited in claim 11, wherein said template description is for at least one of: a floor plan for said first region, a navigational route for said first region, or a wireless node arrangement for said first region.

13. The apparatus as recited in claim 11, wherein said template description is for a wireless node arrangement for said first region and is indicative, at least in part, of at least one of: a signal strength for a signal transmitted by a wireless transmitting device; or a signal propagation time for said signal.

14. The apparatus as recited in claim 10, wherein said first and second regions share a common design characteristic.

15. The apparatus as recited in claim 14, wherein said common design characteristic comprises at least one of: a similar floor plan, a similar navigational route, or a similar wireless node arrangement.

16. The apparatus as recited in claim 10, said processing unit to further:
select said first region of said plurality of regions based, at least in part, on at least one of: a number of common design characteristics, a location, or a usage parameter.

17. The apparatus as recited in claim 16, said processing unit to further:
determine said usage parameter based, at least in part, on feedback from a plurality of mobile devices.

18. The apparatus as recited in claim 10, wherein said portion of said structure comprises one or more buildings and said first and second regions are located:
on different levels of a first one of said one or more buildings;
on one level of said first one of said one or more buildings; or
in different ones of said one or more buildings.

19. An apparatus for use in a computing device, the apparatus comprising:
means for determining a plurality of regions within at least a portion of a structure based, at least in part, on one or more mapped features in an electronic map for said portion of said structure;
means for establishing a template description for a first region of said plurality of regions based, at least in part, on at least a portion of said electronic map; and
means for establishing a map feature distinction for at least a second region of said plurality of regions based, at least in part, on at least a portion of said template description.

20. The apparatus as recited in claim 19, and further comprising:
means for establishing an encoded map feature description comprising said template description and said map feature distinction; and
means for providing at least a portion of said encoded map feature description to a mobile device.

21. The apparatus as recited in claim 20, and further comprising:
means for selecting said first region of said plurality of regions based, at least in part, on at least one of: a number of common design characteristics, a location, or a usage parameter.

22. The apparatus as recited in claim 21, and further comprising:
means for determining said usage parameter based, at least in part, on feedback for a plurality of mobile devices.

23. The apparatus as recited in claim 19, wherein said portion of said structure comprises one or more buildings and said first and second regions are located:
on different levels of a first one of said one or more buildings;
on one level of said first one of said one or more buildings; or
in different ones of said one or more buildings.

24. An article comprising:
a non-transitory computer readable medium having stored therein computer implementable instructions executable by a processing unit in a computing device to:
determine a plurality of regions within at least a portion of a structure based, at least in part, on one or more mapped features in an electronic map for said portion of said structure;
determine a template description for a first region of said plurality of regions based, at least in part, on at least a portion of said electronic map; and
determine a map feature distinction for at least a second region of said plurality of regions based, at least in part, on at least a portion of said template description.

25. The article as recited in claim 24, said computer implementable instructions being further executable by said processing unit to:
establish an encoded map feature description comprising said template description and said map feature distinction.

26. The article as recited in claim 25, said computer implementable instructions being further executable by said processing unit to:
initiate transmission of at least a portion of said encoded map feature description to a mobile device.

27. The article as recited in claim 24, said computer implementable instructions being further executable by said processing unit to:
identify said first region of said plurality of regions based, at least in part, on at least one of: a number of common design characteristics, a location, or a usage parameter.

28. The article as recited in claim 27, said computer implementable instructions being further executable by said processing unit to:
determine said usage parameter based, at least in part, on feedback for a plurality of mobile devices.

29. A method comprising, at a mobile device:
obtaining an encoded map feature description corresponding to a plurality of regions of at least a portion of a structure, said encoded map feature description comprising template description for a first region of said plurality of regions, and a map feature distinction for at least a second region of said plurality of regions; and
determining a decoded map feature description for at least said second region based, at least in part, on said template description and said map feature distinction.

30. The method as recited in claim 29, wherein said decoded map feature description is for at least one of: a floor plan for said second region, a navigational route for said second region, or a wireless node arrangement for said second region.

31. The method as recited in claim 29, wherein said decoded map feature description is for a wireless node arrangement for said second region and is indicative, at least in part, of at least one of: a signal strength for a signal transmitted by a wireless transmitting device; or a signal propagation time for said signal.

32. The method as recited in claim 29, wherein said portion of said structure comprises one or more buildings and said first and second regions are located:
on different levels of a first one of said one or more buildings;
on one level of said first one of said one or more buildings; or
in different ones of said one or more buildings.

33. An apparatus comprising:
memory; and
a processing unit to:
access an encoded map feature description corresponding to a plurality of regions of at least a portion of a structure, said encoded map feature description comprising template description for a first region of said plurality of regions, and a map feature distinction for at least a second region of said plurality of regions; and
establish a decoded map feature description for at least said second region based, at least in part, on said template description and said map feature distinction.

34. The apparatus as recited in claim 33, wherein said decoded map feature description is for at least one of: a floor plan for said second region, a navigational route for said second region, or a wireless node arrangement for said second region.

35. The apparatus as recited in claim 33, wherein said decoded map feature description is for a wireless node arrangement for said second region and is indicative, at least in part, of at least one of: a signal strength for a signal transmitted by a wireless transmitting device; or a signal propagation time for said signal.

36. The apparatus as recited in claim 33, wherein said portion of said structure comprises one or more buildings and said first and second regions are located:
on different levels of a first one of said one or more buildings;
on one level of said first one of said one or more buildings; or
in different ones of said one or more buildings.

37. An apparatus for use in a mobile device, the apparatus comprising:
means for obtaining an encoded map feature description corresponding to a plurality of regions of at least a portion of a structure, said encoded map feature description comprising template description for a first region of said plurality of regions, and a map feature distinction for at least a second region of said plurality of regions; and
means for generating a decoded map feature description for at least said second region based, at least in part, on said template description and said map feature distinction.

38. The apparatus as recited in claim 37, wherein said decoded map feature description is for at least one of: a floor plan for said second region, a navigational route for said second region, or a wireless node arrangement for said second region.

39. The apparatus as recited in claim 37, wherein said decoded map feature description is for a wireless node arrangement for said second region and is indicative, at least in part, of at least one of: a signal strength for a signal transmitted by a wireless transmitting device; or a signal propagation time for said signal.

40. The apparatus as recited in claim 37, wherein said portion of said structure comprises one or more buildings and said first and second regions are located:
on different levels of a first one of said one or more buildings;
on one level of said first one of said one or more buildings; or
in different ones of said one or more buildings.

41. An article comprising:
a non-transitory computer readable medium having stored therein computer implementable instructions executable by a processing unit in a mobile device to:
obtain an encoded map feature description corresponding to a plurality of regions of at least a portion of a structure, said encoded map feature description comprising template description for a first region of said plurality of regions, and a map feature distinction for at least a second region of said plurality of regions; and
determine a decoded map feature description for at least said second region based, at least in part, on said template description and said map feature distinction.

42. The article as recited in claim 41, wherein said decoded map feature description is for at least one of: a floor plan for said second region, a navigational route for said second region, or a wireless node arrangement for said second region.

43. The article as recited in claim 41, wherein said decoded map feature description is for a wireless node arrangement for said second region and is indicative, at least in part, of at least one of: a signal strength for a signal transmitted by a wireless transmitting device; or a signal propagation time for said signal.

44. The article as recited in claim 41, wherein said portion of said structure comprises one or more buildings and said first and second regions are located:
on different levels of a first one of said one or more buildings;
on one level of said first one of said one or more buildings; or
in different ones of said one or more buildings.
